(19) United States
(12) Patent Application Publication
(10) Pub. No.: US 2008/0217878 A1
(43) Pub. Date: Sep. 11, 2008

(54) Spray paint assistant

(76) Inventor: Ernest Cephas, Cincinnati, OH (US)

Correspondence Address: Raymond M. Galasso;Galasso & Associates LP, P.O. Box 26503, Austin, TX, 78755-0503, US

(21) Appl. No.: 11/715,227

(22) Filed: Mar. 7, 2007

(51) Int. Cl. B62B 3/00

(52) U.S. Cl. 280/47.35

(57) ABSTRACT

The Spray Paint Assistant is a cart that can be used to transport and utilize conventional spray-painting equipment and attachments. One embodiment of the invention utilizes a cart having a guide handle and wheels, a utility tray on the cart, a rod on a pivot connected to a support pole, a rod handle connected to the rod, a holder for a pumping unit or a compressor, a rod extension, and a nozzle holder with a clip to hold a spray nozzle. Other embodiments have holes imbedded into the cart, compartments protruding from the cart or clips attached to the cart for holding different style rollers, nozzles or guns. To use the preferred embodiment of The Spray Paint Assistant, a user would attach all spray-painting components to the cart and position the cart at the work site using the guide handle. The rod handle can be used to manipulate the rod and nozzle holder once the spray nozzle is connected to the nozzle holder by the clip. The rod extension can be inserted into the rod if additional length is necessary for a painting job. The painter can move the cart via the handle as the painting project progresses.

### BACKGROUND

Almost all adults in the United States have painted a wall or other object in their lives. Painting is a necessary task associated with new construction projects and many home improvement projects.

Spray-painting is particularly popular because of the ease of painting in that manner compared with traditional roller or brush painting. However, spray-painting requires many components such as a compressor, hose and spray gun/nozzle or a pumping unit, hose and spray gun/nozzle. Unfortunately, all of this equipment can be difficult to transport and use due to its bulk and weight. Many individuals have been hurt or experienced discomfort from holding the spraying equipment in an upright position for a length of time to paint a wall. Others simply do not have the strength to hold the spraying equipment and must either forego spray-painting altogether or hire someone to do a project at great expense.

Hence, there is a need in the art for a convenient to use, inexpensive, durable, safe and effective device for transporting and using conventional spray guns/nozzles and the associated equipment.

### SUMMARY OF THE DISCLOSURE

The Spray Paint Assistant is a cart that can be used to transport and utilize conventional spray-painting equipment and attachments.

One embodiment of the invention utilizes a cart having a guide handle and wheels, a utility tray on the cart, a rod on a pivot connected to a support pole, a rod handle connected to the rod, a holder for a pumping unit or a compressor, a rod extension, and a nozzle holder with a clip to hold a spray nozzle. Other embodiments have holes or clips attached to the cart for holding different style rollers, nozzles or guns.

The principal object of this invention is to provide a device for using spray-painting equipment without causing discomfort or injury to a user.

Another object of this invention is to provide a device for transporting spray-painting equipment.

Another object of this invention is to provide an affordable device for transporting and using spray-painting equipment.

Another object of this invention is to provide a safe device for transporting and using spray-painting equipment.

Another object of this invention is to provide a durable device for transporting and using spray-painting equipment.

Yet another object of this invention is to provide an easily cleaned device for transporting and using spray-painting equipment.

### BRIEF DESCRIPTION OF THE DRAWINGS

FIG. 1 depicts a perspective view of the preferred embodiment of the present invention with the rod extension, nozzle holder and hose and spray nozzle detached.

FIG. 2 depicts a perspective view of the roller attachment that can be used with the preferred embodiment.

FIG. 3 depicts a perspective view of the multi-nozzle sprayer attachment that can be used with the preferred embodiment.

### DETAILED DESCRIPTION OF THE DRAWINGS

The preferred embodiment of The Spray Paint Assistant is comprised of at least some of the following: a cart having a guide handle and wheels, a utility tray on the cart, a rod on a pivot connected to a support pole, a rod handle connected to the rod, a holder for a pumping unit or a compressor, a rod extension, and a nozzle holder with a clip to hold a spray nozzle.

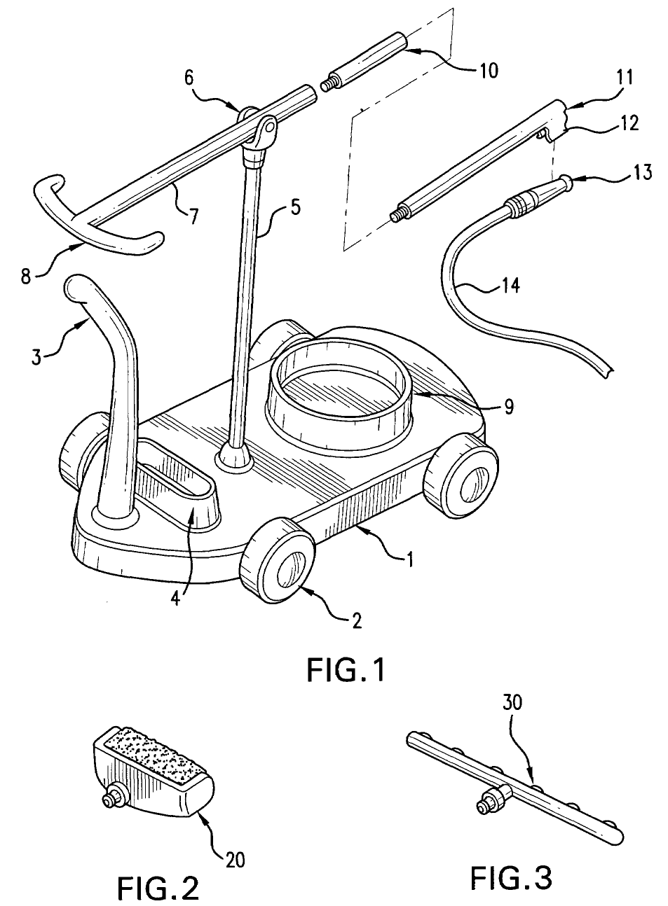

FIG. 1 depicts a perspective view of the preferred embodiment of the present invention with the rod extension, nozzle holder and hose and spray nozzle detached. A cart 1 that is approximately rectangular with curved ends is connected to four wheels 2 on the corners of the cart 1. The wheels 2 are made of rubber and have five-inch diameters and are two inches thick in this preferred embodiment. The cart 1 is approximately three feet long, two feet wide and two inches thick and made of plastic in the preferred embodiment though a variety of sizes and materials could be utilized.

A guide handle 3 made of plastic is connected to the top of one end of the cart 1. The guide handle 3 is approximately cylindrical and tapers and curves toward the top. The guide handle 3 has approximately a three-inch diameter where it connects with the cart 1. The guide handle 3 is two feet long and has a one and a half inch diameter and curves outward from the cart 1 at the top.

A utility tray 4 made of plastic and shaped like an oval protrudes from the top of the cart 1 near the guide handle 3. The utility tray 4 is eighteen inches wide and has sides that are two inches high in this preferred embodiment. The utility tray 4 is located in front of the guide handle 3 and is capable of holding a variety of devices and components used during spray-painting.

A support pole 5 is centrally located and connected to the cart 1. The support pole 5 is made of plastic though it may also be made of metal or other materials. The support pole 5 is cylindrical with a diameter of one inch and a half and a height of three feet. A U-shaped pivot 6 made of metal is located on top of the support pole 5 and connects to a rod 7 made of plastic. The rod 7 is cylindrical with a length of approximately two feet and a diameter of two inches. The rod 7 connects with a rod handle 8 extending slightly beyond the guide handle 3 so as not to interfere with the guide handle 3 when it is maneuvered. The rod handle 8 is also made of plastic and is U-shaped with a width of approximately one foot.

A holder 9 made of plastic and circular in shape protrudes from the top of the cart 1 on the end opposite the guide handle 3. The holder 9 is eighteen inches in diameter and has sides that are two inches high in this preferred embodiment. The holder 9 is located in front of the support pole 5 and is capable of holding a pumping unit or a compressor used for spray-painting.

A rod extension 10 made of plastic provides extra length to the rod 7 when attached. The rod extension 10 has one end that is dimensioned to fit within the end of the rod 7. The rod extension 10 is approximately cylindrical and is eighteen inches long and has a diameter of two inches. A variety of other sizes and shapes, however, may also be utilized for the rod extension. Although a variety of attaching mechanisms are well known for connecting a rod extension to a rod, the preferred embodiment simply provides a threaded connector on one end of the rod extension that fits within grooves cut into the interior of the rod.

A nozzle holder 11 made of plastic that is approximately cylindrical has an end that is dimensioned to fit within the end of the rod 7 or the rod extension 10 in the same manner the rod extension 10 fits inside the rod 7. The nozzle holder 11 has a length of two feet and a diameter of two inches. A U-shaped plastic clip 12 is located on the end of the nozzle holder 11 opposite its attaching mechanism. The plastic clip 12 is dimensioned to fit a standard spray nozzle or spray gun. A standard spray nozzle 13 with a hose 14 is also shown in FIG. 1.

FIG. 2 depicts a perspective view of the roller attachment that can be used with the preferred embodiment. The roller attachment 20 has an end dimensioned to fit into a standard spray nozzle or gun like the one shown in FIG. 1. The roller attachment 20 can either fit into the utility tray described in FIG. 1 or a separate compartment protruding from the cart and dimensioned to specifically fit a roller attachment.

FIG. 3 depicts a perspective view of the multi-nozzle sprayer attachment that can be used with the preferred embodiment. The multi-nozzle sprayer attachment 30 has an end dimensioned to fit into a standard spray nozzle or gun like the one shown in FIG. 1. The multi-nozzle sprayer attachment 30 can either fit into the utility tray described in FIG. 1 or in a separate compartment protruding from the cart and dimensioned to specifically fit a multi-nozzle sprayer attachment.

Other embodiments could have other compartments protruding from the cart or clips attached to the cart for holding different style rollers, nozzles or guns. In addition, the holder, utility tray and other compartments could be imbedded into the cart rather than protruding from the cart and could be in a variety of locations on the cart. The rod could also simply have a clip on the end for holding a spray nozzle without the need for an extension or nozzle holder.

To use the preferred embodiment of The Spray Paint Assistant, a user would attach all spray-painting components to the cart and position the cart at the work site using the guide handle. The rod handle can be used to manipulate the rod and nozzle holder once the spray nozzle is connected to the nozzle holder by the clip. The rod extension can be inserted into the rod if additional length is necessary for a specific painting job. The painter can move the cart via the handle as the painting project progresses.

The materials utilized for The Spray Paint Assistant may vary widely but will likely include plastic and metal. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of The Spray Paint Assistant can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the components of the present invention can be of various shapes and sizes. It should also be obvious that the components of the invention can be made of different types of plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A spray-painting device comprising:
(a) a cart having a set of wheels;
(b) a support pole connected to the cart; and
(c) a pivot located on top of the support pole and connected to a rod.

2. The device of claim 1 wherein the cart is approximately rectangular.

3. The device of claim 1 wherein the cart is made of plastic.

4. The device of claim 2 wherein the cart has curved ends.

5. The device of claim 1 wherein each of the set of wheels is made of rubber.

6. The device of claim 1 further comprising
a guide handle connected to one end of the cart.

7. The device of claim 6 wherein the guide handle tapers and curves toward the top.

8. The device of claim 1 further comprising
a utility tray protruding from the top of the cart.

9. The device of claim 8 wherein the utility tray is shaped like an oval.

10. The device of claim 1 wherein the support pole is centrally located on the cart.

11. The device of claim 1 wherein the pivot is made of metal.

12. The device of claim 1 wherein the pivot is U-shaped.

13. The device of claim 1 further comprising
a rod handle on the end of the rod.

14. The device of claim 13 wherein the rod handle is U-shaped.

15. The device of claim 1 further comprising
a holder located on the cart.

16. The device of claim 1 further comprising
a rod extension with an end dimensioned to fit within the rod.

17. The device of claim 16 further comprising
a nozzle holder with an end dimensioned to fit within the rod extension.

18. The device of claim 17 further comprising
a clip located on the end of the nozzle holder.

19. The device of claim 18 wherein the clip is U-shaped.

20. A spray-painting device comprising:
(a) a cart made of plastic that is approximately rectangular with rounded ends having a set of four wheels made of rubber;
(b) a support pole connected to approximately the center of the cart;
(c) a U-shaped pivot located on top of the support pole and connected to a rod;
(d) a U-shaped rod handle located on one end of the rod;
(e) a guide handle that tapers and curves connected to one end of the cart;
(f) a holder shaped like a circle that protrudes from the top of the cart;
(g) a utility tray protruding from the top of the cart in front of the guide handle and shaped like an oval;
(h) a rod extension with an end dimensioned to fit within the rod;
(i) a nozzle holder with an end dimensioned to fit within the rod extension; and
(j) a U-shaped clip located on the end of the nozzle holder opposite the end dimensioned to fit within the rod extension.
